(19) United States
(12) Patent Application Publication
(10) Pub. No.: US 2018/0192569 A1
(43) Pub. Date: Jul. 12, 2018

(54) A PLOUGH SYSTEM

(71) Applicant: AGRO INTELLIGENCE APS, Aarhus N (DK)

(72) Inventors: Ole Green, Lem St. (DK); Soren Kirkegaard Nielsen, Silkeborg (DK)

(21) Appl. No.: 15/742,443

(22) PCT Filed: Jul. 8, 2016
(86) PCT No.: PCT/DK2016/000028

§ 371 Date: Jan. 5, 2018

(30) Foreign Application Priority Data
Jul. 8, 2015 (DK) PA 2015 00395

(51) Int. Cl. A01B 3/36; A01B 63/00; A01B 69/00

(52) U.S. Cl. CPC A01B 3/36; A01B 69/003; A01B 63/008

(57) ABSTRACT

The present invention relates to a plough system (100) comprising: i) a plough frame (2), said plough frame comprising coupling means (4) for coupling said plough frame to a towing vehicle; wherein said plough frame having an extension in a lengthwise direction (X), and an extension in a transverse direction (Y); wherein said plough frame comprising two or more lifting means (6,6′); said lifting means comprising a fixed part (8) being mounted on said plough frame (2), and a moving part (10) carrying a plough shear (12, 12′); wherein each said lifting means (6,6′) comprising an actuator (14, 14′); wherein said actuator being configured to allow altering of said plough shears (12, 12′) from a lowered position to a raised position, and vice versa; wherein said plough shears (12,12′) being arranged on said frame in mutual staggered orientation in relation to a lengthwise direction as well as to a transverse direction; ii) a control unit (16) configured to receive controlling input (18), and in response thereto independently activate one or more actuators (14, 14′) associated with said lifting means; thereby enabling independent raising and/or lowering of one or more of said plough shears (12,12′). The plough system provides improved ploughing quality of fields of soil comprising a mainland and a headland.

### FIELD OF THE INVENTION

The present invention relates in a first aspect to a plough system for ploughing soil. The present invention relates in a second aspect to the use of a plough system of the first aspect for ploughing soil. The present invention relates in a third aspect to a method of ploughing.

### BACKGROUND OF THE INVENTION

Within the field of agriculture ploughing has been around a long time as an effective tillage method.

Ploughing is used as a way to prepare the soil for seeding. When ploughing the soil is turned around, so that soil previously located in a certain depth will appear as a top layer of the soil. A typical ploughing depth is 18 to 20 cm, but can vary between 5 and 100 cm.

The turning of the soil upon ploughing will provide for aerating the soil and in this way will provide mineralization of soil and better drainage of water which improve fertility. Also, ploughing will remove residues of last year's crops as well as removal of any weed present on the ploughed field. In this way ploughing may be used as a mechanical weed control method, especially in ecological agriculture where herbicides are forbidden.

Today's ploughs comprise a frame to be towed behind or carried by a tractor or the like. The frame carries a number of plough bodies arranged inline in a staggered configuration in relation to a direction transversal to the direction of movement and to the direction of movement itself. The frame comprises a hoist mechanism for raising from the soil or lowering into the soil all the plough shears simultaneously.

When ploughing a field the farmer usually, at least mentally, divide the land to be ploughed into a main part comprising a regularly shaped inner part (the main land) of the field and a surrounding headland. In this way the farmer can concentrate in first ploughing the main part by following a regular serpentine path, whereas the headland is used for turning the tractor in order to plough a subsequent leg of the serpentine path. After having ploughed the inner main part of the field, the farmer ploughs the headland.

When ploughing the inner main part of the field, the farmer raises all the plough shears from the soil upon entering the headland. Similarly when moving from the headland into the main, inner part of the field, the farmer lowers all the plough shears into the soil.

Although this way of performing the ploughing has proven efficient, there are however some drawback using this technique.

One drawback is, that due to the fact that all the plough shears are arranged in a staggered configuration which is not perpendicular to the direction of movement of the plough through the soil, it will not be possible, at the boundary between the inner, main part of the field and the headland to exactly and precisely plough the soil up to this boundary.

If the farmer wishes to plough all the inner, main part of the field, the ploughing will in respect of some plough shears—due to the staggered configuration of the plough shears—inevitably plough into the headland.

Consequently, when the farmer after having ploughed the whole area of the inner, main part of the field, subsequently ploughs the headland, part of the soil of the headland, will be ploughed again and thus become turned around twice.

Turning around soil twice corresponds to some extent to not turning around the soil at all, at least when it comes to allow weed to continue growth.

Accordingly, part of the headland will exhibit areas of soil in which the weed, which was supposed to be buried with soil during ploughing, will have an initial advantage in terms of rooting and growth, compared to the crops being sown.

This obviously has the consequence that the crop seeds to be sown will encounter so much competition from the weed that has been turned around twice, that the growth conditions for these seeds and hence the total economical crop yield will be far from optimum.

Additionally, the overlap will result in an uneven surface after ploughing, while the boundary of the ploughing of the main land conflicts with the following ploughing of the headland.

Furthermore, ploughing the headland will due to ploughing the soil twice result in a situation, where crop residues at least partly will not be covered by soil.

Hence, there is a need for an improved plough system which overcomes these disadvantages.

It is an object of the present invention to provide a plough system which overcomes the above-identified disadvantages.

### BRIEF DESCRIPTION OF THE INVENTION

This object is fulfilled by a plough system having the features as defined in claim 1, by the use having the features as defined in claim 22 and the method having the features as defined in claim 23.

Preferred embodiments are defined in the dependent claims and explained in the following description and illustrated by the accompanying drawings.

Accordingly, the present invention relates in a first aspect to a plough system comprising:

i) a plough frame, said plough frame comprising coupling means for coupling said plough frame to a towing vehicle;
wherein said plough frame having an extension in a lengthwise direction, and an extension transverse direction;
wherein said plow frame comprising two or more lifting means; said lifting means comprising a fixed part being mounted on said plough frame, and a moving part carrying a plough shear;
wherein each said lifting means comprising an actuator;
wherein said actuator being configured to allow altering of said plough shear from a lowered position to a raised position, and vice versa;
wherein said plough shears being arranged on said frame in mutual staggered orientation in relation to a lengthwise direction as well as to a transverse direction;

ii) a control unit configured to receive controlling input, and in response thereto independently activate one or more actuators associated with said lifting means; thereby enabling independent raising and/or lowering of one or more of said plough shears.

In a second aspect the present invention relates to a use of a plough system according to the first aspect of the present invention for ploughing a field at least partly surrounded by a headland.

In a third aspect the present invention relates to a method for ploughing a field, at least partly surrounded by a headland, said method comprising:
i) defining coordinates of one or more boundaries between an inner, main field to be ploughed and the surrounding headland;
ii) providing a plough system comprising a plough frame having an extension in a lengthwise direction, and an extension transverse direction; said plow frame comprising two or more lifting means; said lifting means comprising a fixed part being mounted on said plough frame, and a moving part carrying a plough shear; wherein said lifting means comprising an actuator; wherein said actuator being configured to allow altering said plough shear from a lowed position to a raised position and vice versa; wherein said plough shears being arranged in a mutual staggered orientation in relation to a lengthwise direction as well as to a transverse direction;
ii) ploughing a field of soil by moving the plough shears through the soil of the inner, main field to be ploughed;
iii) in respect of each of the plough shears, raising a specific plough shears in case a specific plough shear is crossing the boundary between the inner, main field to be ploughed and an associated headland, in a direction from the inner, main field to be ploughed to the headland;
iv) in respect of each of the plough shears, lowering a specific plough shears in case a specific plough shear is crossing the boundary between the inner, main field to be ploughed and an associated headland, in a direction from the headland to the inner, main field to be ploughed.
v) ploughing the area of the headland at least partly surrounding the inner, main field.

The present invention in its first, second and third aspects provide for improved germination and growth conditions for crops seeds which are being sown in a field comprising an inner, main field, which is at least partly surrounded by a headland, subsequent to ploughing thereof.

Additionally, the present invention in its various aspects provides for a more efficient ploughing in that necessity to plough certain areas of the field twice is avoided.

### BRIEF DESCRIPTION OF THE FIGURES

FIG. 1 is a plan view of a field being ploughed with a prior art ploughing system.

FIG. 2 is a perspective view illustrating a ploughing system according to the first aspect of the present invention.

FIG. 3 is a schematic drawing illustrating the structure of a controlling system for controlling a plough system of the first aspect of the present invention.

### DETAILED DESCRIPTION OF THE INVENTION

The present invention relates in a first aspect to a plough system comprising:

i) a plough frame, said plough frame comprising coupling means for coupling said plough frame to a towing vehicle;
wherein said plough frame having an extension in a lengthwise direction, and an extension transverse direction;
wherein said plow frame comprising two or more lifting means; said lifting means comprising a fixed part being mounted on said plough frame, and a moving part carrying a plough shear;
wherein each said lifting means comprising an actuator;
wherein said actuator being configured to allow altering of said plough shear from a lowered position to a raised position, and vice versa;
wherein said plough shears being arranged on said frame in mutual staggered orientation in relation to a lengthwise direction as well as to a transverse direction;

ii) a control unit configured to receive controlling input, and in response thereto independently activate one or more actuators associated with said lifting means; thereby enabling independent raising and/or lowering of one or more of said plough shears.

The plough system according to the first aspect of the present invention allows for raising/lowering each plough shear independently upon crossing a boundary between a main land and a headland. Thereby double ploughing of the headland can be avoided. This result is brought about by the plough system comprising means for individually raising from or lowering into the soil the plough shears.

It should be noted that in the present description and in the appended claims the noun “controlling input” shall be interpreted as being input provided by human interaction, either directly by manual instruction or by an automatically system which has been programmed in accordance with predetermined criteria for raising/lowering the individually plough shears, e.g. in response to geographical coordinates.

Accordingly, in the present description and in the appended claims the noun “controlling input” shall not be interpreted as a “mechanical input” in the sense of a mechanical impact between a stone, a boulder or a rock located in the soil and the plough shear which will imply raising/lowering of a plough shear, such as it is known in respect of plough systems which comprise a stone release system as described in more detail below.

In one embodiment of the first aspect of the present invention, said actuators are independently being selected from the group comprising, hydraulic actuators, electric actuators, and pneumatic actuators.

In one embodiment of the first aspect of the present invention said actuators are being hydraulic actuators and wherein said control unit comprises hydraulic valves configured for activating said hydraulic actuators; or wherein said actuators are being electric actuators and wherein said control unit comprises electric switches configured for activating said electric actuators; or wherein said actuators are being pneumatic actuators and wherein said control unit comprises pneumatic valves configured for activating said pneumatic actuators.

Such actuators and types of control system have proven efficient for the intended purpose.

In one embodiment of the first aspect of the present invention in which said actuators are being hydraulic actuators it will also be possible to provide the plough system with measuring means for measuring and optionally logging the hydraulic pressure in each of the hydraulic actuators. Similar types of measuring means, and logging, may be provided in respect of electrical or pneumatic actuators.

In one embodiment of the first aspect of the present invention the plough system comprises 2-40 plough shears, such as 4-35 plough shears, for example 6-30 plough shears, such as 10-25 plough shears, e.g. 15-20 plough shears.

These numbers of plough shears are common in modern plough systems and thereby suit the modern demands for ploughing systems.

In one embodiment of the first aspect of the present invention said plough system is a reversible plough or a non-reversible plough.

The plough system according to the first aspect of the present invention is equally well-suited for reversible ploughs and for non-reversible ploughs.

In one embodiment of the first aspect of the present invention the two or more lifting means being configured in such a way that the raising and lowering of the plough shears are being performed by a pivotally movement of the moving part carrying the plough shear.

In one embodiment of the first aspect of the present invention the system is designed in such a way that in respect of one or more of said lifting means, preferably in respect of all said lifting means, said lifting means are being configured in such a way that one end of said actuator is being pivotally mounted to said fixed part of said lifting means, and in such a way that the opposite end of said actuator is being pivotally mounted to said moving part of said lifting means, wherein said two opposite ends of said actuator are being moveable in relation to each other.

This embodiment provides a simple type of construction of the feature of raising/lowering of the plough shear. Additionally this type of construction allows using a plough having a stone release system as a plough system forming the basis for the plough system according to the first aspect of the present invention. A stone release system is a plough system comprising pivotally suspended plough shears. The plough shears are being suspended and controlled by a hydraulic controller which comprises a number of hydraulic valves and tubings. A stone release system allows each plough shear to pivot in a backward direction in case a specific plough shear hits a large stone, rock or boulder in the soil, thereby avoiding mechanical destruction of the plough shears by impact with stones, rocks or boulders. The size of the impact necessary for allowing a specifically plough shear to pivot is predetermined and adjustable. Once a specific plough shears has hit a stone, rock or boulder in the soil and has pivoted backward, hydraulic valves will imply that a hydraulic pressure is reestablished so that that specific plough shear regains its lowered position into the soil.

In one embodiment of the first aspect of the present invention, the plough system comprises a stone release mechanism and wherein said two or more lifting means being integrated with said stone release mechanism.

In one embodiment of the first aspect of the present invention the plough system further comprises an interphase, said interphase being configured so as to enable providing instructions to an actuator in relation to independently lowing/raising a specific plough shear.

In one embodiment of the first aspect of the present invention said interphase being configured to enable providing instructions to said actuator in relation to independently lowing/raising a specific plough shear, by providing controlling input to said control unit.

An interphase may serve as an intermediate unit between the control unit and the specific lifting means of the plough shears, thereby effecting the raising and/or lowering of the plough shears.

In one embodiment of the first aspect of the present invention, the plough system furthermore comprising input means, such a keyboard or a tablet for programming said interphase; said system optionally furthermore comprising a monitor.

In one embodiment of the first aspect of the present invention said monitor is being configured for monitoring the settings and/or the status of the operation of the plough system.

Input means and a monitor allows a user to input data to the system in relation to program the system with the view to provide an automatically controlled plough system. Further, the monitor allows monitoring the settings and performance of the system during use. This will enable monitoring and controlling by an operator, the proper functioning of the plough system during use thereof.

In one embodiment of the first aspect of the present invention the plough system further comprising a data storage; said data storage being configured to allow storing of coordinates relating to one or more boundaries between a main, inner field to be ploughed and a surrounding headland.

A data storage allows for automatically control a ploughing of soil.

In one embodiment of the first aspect of the present invention, the interphase being configured to receive position indication coordinates from a position indication receiver.

In one embodiment of the first aspect of the present invention, the position indication coordinates are provided by a satellite navigation system, such as a Global Navigation Satellite System (GNSS), such as a GPS system.

In one embodiment of the first aspect of the present invention, the system further comprising one or more of such a position indication receiver, such as a satellite navigation system, for example a GPS system.

In one embodiment of the first aspect of the present invention, the number of position indicating receivers is equal to the number of plough shears; and wherein a position indication receiver is being arranged at the position of each plough shear.

Providing the plough system with one or more position indication receiver allows knowing with great accuracy, at any given time, the position of that position indication receiver. This will allow knowing, at any given time, the position of one or more, preferably all, of said plough shears.

In one embodiment of the first aspect of the present invention, the plough system further comprising a data storage configured to enable storing thereon, data relating to the relative position of the one or more, preferably all, of said plough shears, in relation to said position indication receiver, and wherein said interphase being configured to calculate, on the basis thereof and on the basis of the coordinates received by a position indication receiver, the absolute coordinates of the one or more, preferably all of the plough shares.

Such systems enables constantly knowing the exact position of each of the plough shears and thereby allows determining whether a specific plough shear is to be lowered into the soil or raised above the soil.

In one embodiment of the first aspect of the present invention said control unit is being configured for automatically controlling said activation of one or more actuators with the view to automatically and independently raising and/or lowering of one or more of said plough shears.

This will allow an easy and convenient precise ploughing operation by the user, thereby making the ploughing operation more efficient.

In one embodiment of the first aspect of the present invention, the plough system being configured, via said interphase, to provide signals to said control unit relating to instructions of independently lowering or raising one or more plough shears according to a predetermined strategy.

In one embodiment of the first aspect of the present invention, said predetermined strategy comprises the following elements:
a) in case a specific plough shear being located within the inner, main field to be ploughed, said plough shear must be arranged in a lowered position;
b) in case a specific plough shear being located within a headland, said plough shear must be arranged in a raised position;
c) in case a specific plough shear is crossing the boundary between the inner, main field to be ploughed and an associated headland, in a direction from the inner, main field to be ploughed to the headland, that specific plough shear must change position from a lowered position to a raised position;
d) in case a specific plough shear is crossing the boundary between the inner, main field to be ploughed and an associated headland, in a direction from the headland to the inner, main field to be ploughed, that specific plough shear must change position from a raised position to a lowered position.

Such a strategy allows automatically controlling of the plough system.

In a second aspect the present invention relates to a use of a plough system according to the first aspect of the present invention for ploughing a field at least partly surrounded by a headland.

In a third aspect the present invention relates to a method for ploughing a field, at least partly surrounded by a headland, said method comprising:
i) defining coordinates of one or more boundaries between an inner, main field to be ploughed and the surrounding headland;
ii) providing a plough system comprising a plough frame having an extension in a lengthwise direction, and an extension transverse direction; said plow frame comprising two or more lifting means; said lifting means comprising a fixed part being mounted on said plough frame, and a moving part carrying a plough shear; wherein said lifting means comprising an actuator; wherein said actuator being configured to allow altering said plough shear from a lowed position to a raised position and vice versa; wherein said plough shears being arranged in a mutual staggered orientation in relation to a lengthwise direction as well as to a transverse direction;
ii) ploughing a field of soil by moving the plough shears through the soil of the inner, main field to be ploughed;
iii) in respect of each of the plough shears, raising a specific plough shears in case a specific plough shear is crossing the boundary between the inner, main field to be ploughed and an associated headland, in a direction from the inner, main field to be ploughed to the headland;
iv) in respect of each of the plough shears, lowering a specific plough shears in case a specific plough shear is crossing the boundary between the inner, main field to be ploughed and an associated headland, in a direction from the headland to the inner, main field to be ploughed.
v) ploughing the area of the headland at least partly surrounding the inner, main field.

In one embodiment of the third aspect of the present invention said raising and lowering of a specific plough shear is being performed automatically.

In one embodiment of the first aspect of the present invention, the method being performed by using a plough system according to the first aspect of the invention.

According to the use and the method of the second and third aspect, respectively, the plough system may be suitable for plough irregularly shaped fields or parts of fields, such as a wedged shaped fields, where not all plough shears are desired to be lowered into the soil at all time. In ploughing such shapes of fields or parts of fields, one or more of the plough shres may be lifted, while one or more of the plough shears are submerged into the soil for ploughing purposes.

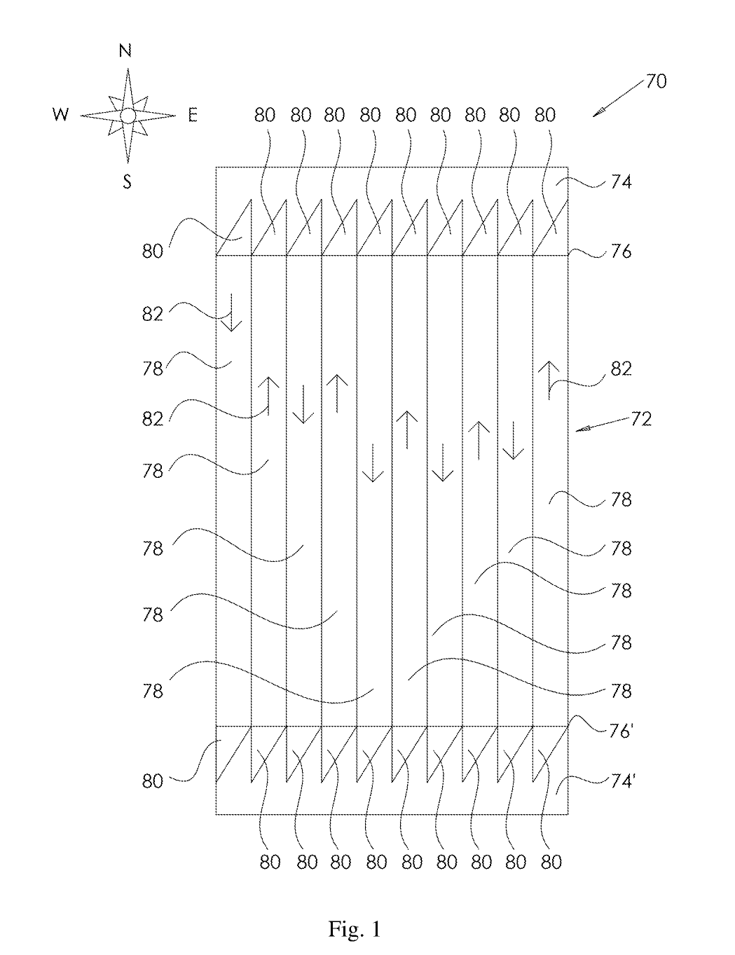

Referring now in detail to the drawings for the purpose of illustrating preferred embodiments of the present invention, FIG. 1 illustrates the problems associated with ploughing using a prior art plough system in which a number of staggered arranged plough shears may only be raised and lowered simultaneously.

FIG. 1 shows a plan view of a field 70 to be ploughed. The field 70 is having a rectangular shape and being oblong in a north-south direction. The field 70 to be ploughed comprises an inner, main field 72. North and south to the inner, main field 72, respectively is located a headland 74,74′.

The northern headland 74 is separated from the inner main field 72 by a boundary 76. Likewise, the southern headland 74′ is separated from the inner main field 72 by a boundary 76′.

When ploughing the field 70 using a traditional and prior art plough system, the farmer will use a plough system having a number of plough shears arranged in a staggered configuration in relation to the longitudinal direction as well as to the transverse direction of the plough system. The rightmost plough shear accordingly is the leading plough shear, whereas the leftmost plough shear is the trailing plough shear.

The farmer will start ploughing in the northern headland 74 in a western end thereof. The farmer will move forward in a southern direction and he will lower all the plough shears simultaneously when the leading rightmost plough shear crosses the boundary 76. This will have the consequence that the part 80 of the headland 74 will be ploughed.

The farmer continues ploughing in a southern direction following the leg 78 of the ploughing trail into the southern headland 74′ and when the trailing and leftmost plough shear crosses the boundary 76′ he well simultaneously raise all the plough shears. This will have the consequence that the part 80 of the headland 74′ will be ploughed.

In the headland 74′ the farmer will turn the vehicle towing the plough system and continue ploughing in a northern direction.

Accordingly, the farmer continues ploughing in this way in a successive southern and northern direction following a serpentine path.

The farmer will finalize ploughing the inner main field 72 when he reaches the eastern part of the northern headland 74.

At this time, all of the inner main field 72 has been ploughed. However, also soil of the parts 80 of the northern headland 74 as well as soil of the parts 80 of the southern headland 74′ will have been ploughed this way.

In order to finish ploughing the field 70, the farmer finally ploughs the northern headland 74 and the southern headland. In this specific example he will follow a western-eastern serpentine path when doing so.

When the field 70 comprising the inner main field 72 and the northern headland 74 as well as the southern headland 74′ have been ploughed, all the parts 80 in the northern headland 74 the southern headland 74′ will have been subjected to ploughing twice which means that any soil in the areas 80 containing weed will have been turned around twice which means that the weed will not have been buried to the extent that the growth conditions for the weed will be impaired.

Accordingly, crop seeds which will subsequently be sown in the soil of the areas 80 will encounter a strong competition in relation to seeding and growth in relation to the weed which was previously present in these areas. For this reason, the areas 80 will not provide optimum growth conditions for the crop seeds to be sown.

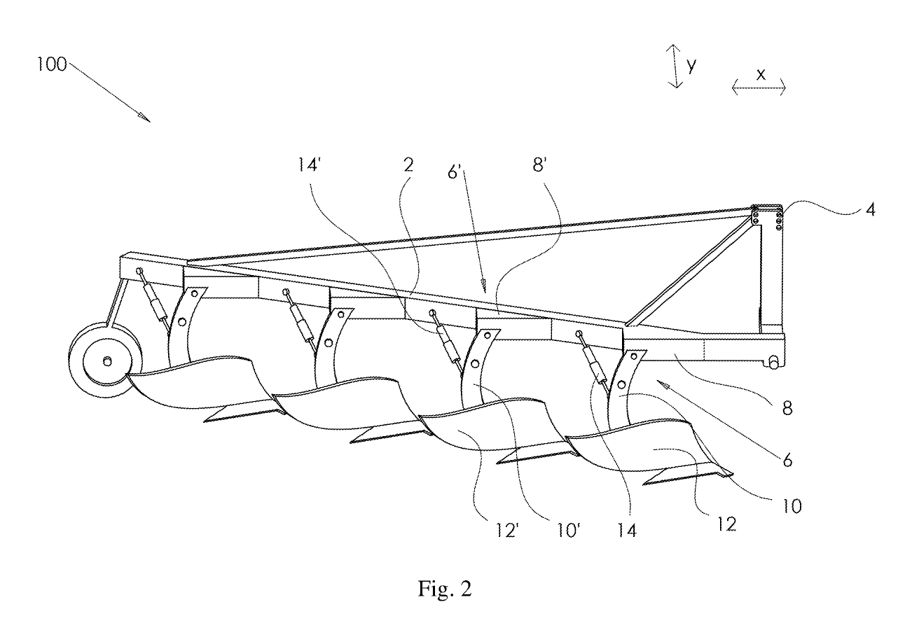

FIG. 2 is a perspective view illustrating a plough system 100 according to the first aspect of the present invention. The plough system 100 comprises i) a plough frame 2; and ii) a control unit 16 (not seen in FIG. 2).

The plough frame 2 comprising coupling means 4 for coupling said plough frame to a towing vehicle; wherein said plough frame having an extension in a lengthwise direction X, and an extension transverse direction Y. The lengthwise direction X is essentially parallel to the intended direction of movement of the plough shear through the soil; whereas the transverse direction Y is essentially perpendicular thereto.

The plough frame comprising two or more lifting means 6,6′ comprising a fixed part 8 being mounted on said plough frame 2, and a moving part 10 carrying a plough shear 12,12′. The moving part 10 is pivotally moveable in relation to the frame 2.

Each said lifting means 6,6′ comprising an actuator 14,14′. Each said actuator being configured to allow altering of said plough shears 12,12′ from a lowered position to a raised position, and vice versa.

The plough shears 12,12′ being arranged on said frame in mutual staggered orientation in relation to a lengthwise direction as well as to a transverse direction.

A control unit 16 (not seen in FIG. 2) is configured to receive controlling input 18, and in response thereto independently activate one or more actuators 14,14′ associated with said lifting means; thereby enabling independent raising and/or lowering of one or more of said plough shears 12,12′.

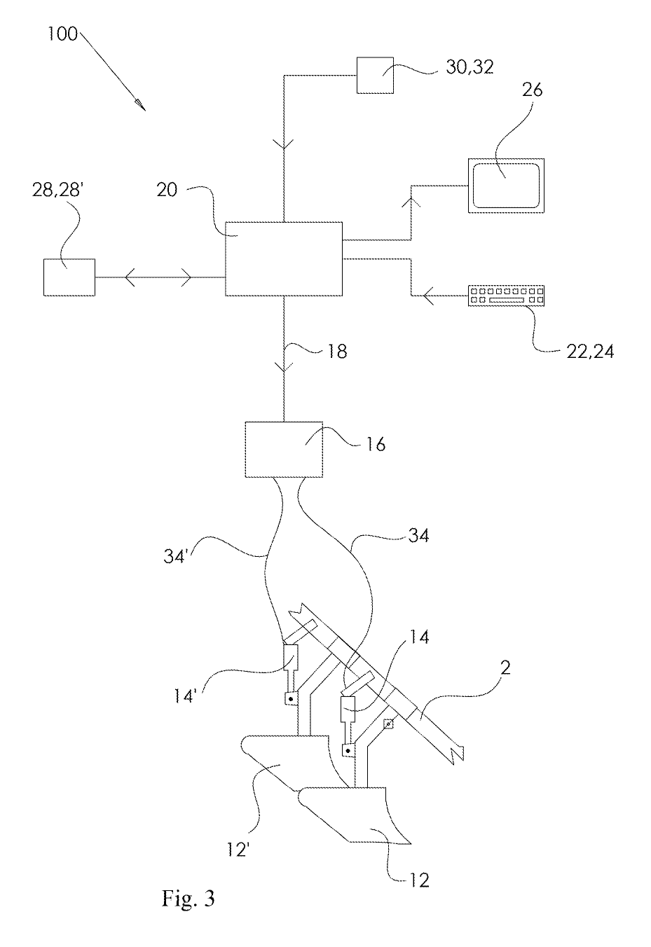

FIG. 3 illustrates one embodiment of a controlling system of the plough system 100 of the first aspect of the present invention. The controlling system comprises an interphase 20.

The interphase being configured to enable providing instructions to an actuator 14,14′ in relation to lowing/raising a specific plough shear 12,12′. This is brought about via the control unit 16 which is a control unit for controlling the hydraulic actuators 14,14′ upon receipt of instructions to this end and by controlling the hydraulic pressure in the hydraulic hoses 34,34′. The actuation of the actuators 14,14′ will effect lowering or rasing the plough shears 12,12 pivotally suspended on the frame 2 of the plough system.

The interphase 20 is being managed or programmed via input means 22 in the form of a keyboard or a tablet 24. A monitor 26 allows an operator to monitor the settings of the interphase.

The interphase 20 comprises a data storage 28. The data storage is configured to allow storing of coordinates relating to one or more boundaries 76,76′ between a main, inner field 72 to be ploughed and a surrounding headland 74,74′.

The interphase 20 is also configured to receive position indication coordinates from a position indication receiver 30 in the form of GNSS, e.g. a GPS satellite navigation system 32.

A data storage 28′ is configured to enable storing thereon, data relating to the relative position of the one or more, preferably all, of said plough shears 12,12′, in relation to said position indication receiver 30. Furthermore, the interphase 20 is configured to calculate, on the basis thereof and on the basis of the coordinates received by the position indication receiver 30, the absolute coordinates of the one or more, preferably all, of the plough shares 12,12′. The data storage 28′ may be the same or different form the data storage 28.

In this way, based on the absolute position of the position indication receiver 30 and the relative position of each plough shear 12,12′, the absolute position of each plough shear 12,12′ will continuously be calculated.

The interphase 20 is configured to provide signals to the control unit 16 relating to instructions of independently lowering or raising one or more plough shears 12,12′ according to a predetermined strategy.

One preferred predetermined strategy comprises the following elements:

a) in case a specific plough shear 12,12′ being located within the inner, main field 72 to be ploughed, said plough shear must be arranged in a lowered position;

b) in case a specific plough shear 12,12′ being located within a headland 74,74′, said plough shear must be arranged in a raised position;

c) in case a specific plough shear 12,12′ is crossing the boundary 76,76′ between the inner, main field to be ploughed and an associated headland 74,74′, in a direction from the inner, main field to be ploughed to the headland, that specific plough shear must change position from a lowered position to a raised position;

d) in case a specific plough shear 12,12′ is crossing the boundary 76,76′ between the inner, main field 72 to be ploughed and an associated headland 74,74′, in a direction from the headland to the inner, main field to be ploughed, that specific plough shear must change position from a raised position to a lowered position.

Accordingly, the plough system 100 schematically illustrated in FIG. 3 allows for independently and automatically controlling the raising and lowering of the plough shears based on the position of each plough shear 12,12′ and based on whether each specific plough shear is located in an inner, main field 72 to be ploughed or in an associated headland 74,74′.

Hence, the plough system depicted in FIG. 3 allows for avoidance of turning part of the soil twice and thereby will improve germination and growth conditions for crops seed to be sown following ploughing.

### LIST OF REFERENCE NUMERALS

2 Plough frame
4 Coupling means
6,6′ Lifting means
8 Fixed part of lifting means
10 Moving part of lifting means carrying a plough shear
12,12′ Plough shear
14,14′ Actuator
16 Control unit
18 Controlling input
20 Interphase
22 Input means
24 Keyboard
26 Monitor
28,28′ Data storage
30 Position indicating receiver
32 Satellite navigation system
34 Hydraulic hose
70 Field to be ploughed
72 Inner, main field to be ploughed
74,74′ Headland at least partly surrounding the main area of field to be ploughed
76,76′ Boundary between inner, main field to be ploughed and headland
78 Legs of ploughing trails
80 Areas subject to ploughing twice
82 Ploughing direction
100 Plough system
X Lengthwise direction
Y Transverse direction

1. A plough system (100) comprising:
i) a plough frame (2), said plough frame comprising coupling means (4) for coupling said plough frame to a towing vehicle;
wherein said plough frame having an extension in a lengthwise direction (X), and an extension in a transverse direction (Y);
wherein said plough frame comprising two or more lifting means (6,6′); said lifting means comprising a fixed part (8) being mounted on said plough frame (2), and a moving part (10) carrying a plough shear (12,12′);
wherein each said lifting means (6,6′) comprising an actuator (14,14′);
wherein said actuator being configured to allow altering of said plough shears (12,12′) from a lowered position to a raised position, and vice versa;
wherein said plough shears (12,12′) being arranged on said frame in mutual staggered orientation in relation to a lengthwise direction as well as to a transverse direction;
ii) a control unit (16) configured to receive controlling input (18), and in response thereto independently activate one or more actuators (14,14′) associated with said lifting means; thereby enabling independent raising and/or lowering of one or more of said plough shears (12,12′).

2. A plough system (100) according to claim 1, wherein said actuators (14,14′) independently being selected from the group comprising: hydraulic actuators, electric actuators, pneumatic actuators.

3. A plough system (100) according to claim 1 or 2, wherein said actuators (14,14′) are being hydraulic actuators and wherein said control unit (16) comprises hydraulic valves configured for activating said hydraulic actuators; or wherein said actuators (14,14′) are being electric actuators and wherein said control unit (16) comprises electric switches configured for activating said electric actuators; or wherein said actuators (14,14′) are being pneumatic actuators and wherein said control unit (16) comprises pneumatic valves configured for activating said pneumatic actuators.

4. A plough system (100) according to any of the claims 1-3 comprising 2-40 plough shears (12,12′), such as 4-35 plough shears, for example 6-30 plough shears, such as 10-25 plough shears, e.g. 15-20 plough shears.

5. A plough system (100) according to any of the preceding claims, wherein said plough system is a reversible plough or a non-reversible plough.

6. A plough system (100) according to any of the preceding claims, wherein said two or more lifting means (6,6′) being configured in such a way that the raising and lowering of the plough shears (12,12′) are being performed by a pivotally movement of the moving part (10) carrying the plough shear (12,12′).

7. A plough system (100) according to any of the preceding claims, wherein in respect of one or more of said lifting means, preferably in respect of all said lifting means, said lifting means are being configured in such a way that one end of said actuator (14,14′) is being pivotally mounted to said fixed part (8) of said lifting means, and in such a way that the opposite end of said actuator is being pivotally mounted to said moving part (10) of said lifting means, wherein said two opposite ends of said actuator are being moveable in relation to each other.

8. A plough system (100) according to any of the preceding claims further comprising an interphase (20), said interphase being configured so as to enable providing instructions to an actuator (14,14′) in relation to independently lowing/raising a specific plough shear (12,12′).

9. A plough system (100) according to claim 8, wherein said interphase being configured to enable providing instructions to said actuator (14,14′) in relation to independently lowing/raising a specific plough shear (12,12′), by providing controlling input to said control unit (16).

10. A plough system (100) according to claim 8 or 9, wherein said system furthermore comprising input means (22), such a keyboard or a tablet (24) for programming said interphase; said system optionally furthermore comprising a monitor (26).

11. A plough system (100) according to claim 10, wherein said monitor (26) is being configured for monitoring the settings and/or the status of the operation of the plough system.

12. A plough system (100) according to any of the preceding claims further comprising a data storage (28); said data storage being configured to allow storing data associated with coordinates relating to one or more boundaries (76,76′) between a main, inner field (72) to be ploughed and a surrounding headland (74,74′).

13. A plough system (100) according to any of the claims 8-12, wherein said interphase (20) being configured to receive position indication coordinates from a position indication receiver (30).

14. A plough system (100) according to claim 9, wherein said position indication coordinates are provided by a satellite navigation system (32), such as a Global Navigation Satellite System (GNSS), such as a GPS system.

15. A plough system (100) according to claim 13 or 14 further comprising one or more of such a position indication receiver, such as a satellite navigation system (32), for example a GPS system.

16. A plough system (100) according to any of the claims 13-15 wherein the number of position indicating receivers is equal to the number of plough shears; and wherein a position indication receiver is being arranged at the position of each plough shear.

17. A plough system (100) according to any of the claims 8-15 further comprising a data storage (28′) configured to enable storing thereon, data relating to the relative position of the one or more, preferably all, of said plough shears (12,12′), in relation to said position indication receiver (30), and wherein said interphase (20) being configured to calculate, on the basis thereof and on the basis of the coordinates received by a position indication receiver, the absolute coordinates of the one or more, preferably all of the plough shares (12,12′).

18. A plough system (100) according to any of the preceding claims wherein said control unit (16) is being configured for automatically controlling said activation of one or more actuators (14,14′) with the view to automatically and independently raising and/or lowering of one or more of said plough shears.

19. A plough system (100) according to any of the claims 1-18, wherein said plough system being configured, via said interphase (20), to provide signals to said control unit (16) relating to instructions of independently lowering or raising one or more plough shears (12,12′) according to a predetermined strategy.

20. A plough system (100) according to claim 19, wherein said predetermined strategy comprises the following elements:
a) in case a specific plough shear (12,12′) being located within the inner, main field (72) to be ploughed, said plough shear must be arranged in a lowered position;
b) in case a specific plough shear (12,12′) being located within a headland (74,74′), said plough shear must be arranged in a raised position;
c) in case a specific plough shear (12,12′) is crossing the boundary (76,76′) between the inner, main field to be ploughed and an associated headland (74,74′), in a direction from the inner, main field to be ploughed to the headland, that specific plough shear must change position from a lowered position to a raised position;
d) in case a specific plough shear (12,12′) is crossing the boundary (76,76′) between the inner, main field (72) to be ploughed and an associated headland (74,74′), in a direction from the headland to the inner, main field to be ploughed, that specific plough shear must change position from a raised position to a lowered position.

21. A plough system (100) according to any of the preceding claims, wherein said plough system comprises a stone release mechanism and wherein said two or more lifting means (6,6′) being integrated with said stone release mechanism.

22. Use of a plough system (100) according to any of the claims 1-21 for ploughing a field (72) at least partly surrounded by a headland (74,74′).

23. A method for ploughing a field (72), at least partly surrounded by a headland (74,74′), said method comprising:
i) defining coordinates of one or more boundaries (76,76′) between an inner, main field (72) to be ploughed and the surrounding headland (74,74′);
ii) providing a plough system (100) comprising a plough frame (2) having an extension in a lengthwise direction (X), and an extension transverse direction (Y); said plow frame comprising two or more lifting means (6,6′); said lifting means comprising a fixed part (8) being mounted on said plough frame, and a moving part (10) carrying a plough shear (12,12′); wherein said lifting means comprising an actuator (14,14′); wherein said actuator being configured to allow altering said plough shear from a lowed position to a raised position and vice versa; wherein said plough shears being arranged in a mutual staggered orientation in relation to a lengthwise direction as well as to a transverse direction;
ii) ploughing a field of soil by moving the plough shears (12,12′) through the soil of the inner, main field (72) to be ploughed;
iii) in respect of each of the plough shears (12,12′), raising a specific plough shears in case a specific plough shear is crossing the boundary (76,76′) between the inner, main field (72) to be ploughed and an associated headland (74,74′), in a direction from the inner, main field to be ploughed to the headland;
iv) in respect of each of the plough shears (12,12), lowering a specific plough shears in case a specific plough shear is crossing the boundary (76,76′) between the inner, main field (72) to be ploughed and an associated headland (74,74′), in a direction from the headland to the inner, main field to be ploughed.
v) ploughing the area of the headland (74,74′) at least partly surrounding the inner, main field (72).

24. A method according to claim 16, wherein said raising and lowering of a specific plough shear (12,12′) is being performed automatically.

25. A method according to claim 23 or 24 performed by using a plough system (100) according to any of the claims 1-21.
